(19) United States
(12) Patent Application Publication
(10) Pub. No.: US 2025/0266498 A1
(43) Pub. Date: Aug. 21, 2025

(54) ELECTROLYTE FOR SECONDARY BATTERY AND METHOD FOR PREPARING SAME

(71) Applicants: Hyundai Motor Company, Seoul (KR); Kia Corporation, Seoul (KR); Korea Advanced Institute of Science and Technology, Daejeon (KR)

(72) Inventors: Ha Eun Lee, Incheon (KR); Sung Ho Ban, Hwaseong (KR); Yong Hoon Kim, Daejeon (KR); Yoon Sung Lee, Suwon (KR); Hui Beom Nam, Suwon (KR); Kwon Gyo Shin, Daejeon (KR); Nam-Soon Choi, Daejeon (KR)

(21) Appl. No.: 18/803,017

(22) Filed: Aug. 13, 2024

(30) Foreign Application Priority Data
Feb. 19, 2024 (KR) 10-2024-0023615

(51) Int. Cl. H01M 10/0567; H01M 10/052; H01M 10/0568; H01M 10/0569

(52) U.S. Cl. CPC H01M 10/0567; H01M 10/052; H01M 10/0568; H01M 10/0569; H01M 2220/20; H01M 2300/0034; H01M 2300/0037; H01M 2300/0088

(57) ABSTRACT

Disclosed are an electrolyte for a lithium secondary battery and a method for preparing the same, wherein the electrolyte improves the charge output characteristics of a secondary battery, especially a secondary battery containing a lithium iron phosphate (LiFePO₄, LFP) cathode active material, by containing methyl 3,3,3-trifluoropropionate (MTFP) as a co-solvent and vinylene carbonate (VC), 1,3-propane sultone (PS), and lithium difluoro(bisoxalato) phosphate (LiDFBP) as additives.

### CROSS-REFERENCE TO RELATED APPLICATION(S)

The present application claims under 35 U.S.C. § 119 (a) the benefit of Korean Patent Application No. 10-2024-0023615, filed on Feb. 19, 2024, the entire contents of which is incorporated herein for all purposes by this reference.

### BACKGROUND

### Technical Field

The present disclosure relates to an electrolyte for a lithium secondary battery and a method for preparing the same, wherein the electrolyte improves charge output characteristics of a secondary battery, especially a secondary battery containing a lithium iron phosphate (LiFePO₄, LFP) cathode active material, by containing methyl 3,3,3-trifluoropropionate (MTFP) as a co-solvent and vinylene carbonate (VC), 1,3-propane sultone (PS), and lithium difluoro(bisoxalato) phosphate (LiDFBP) as additives.

### Background

Lithium secondary batteries are widely used in portable energy storage devices, electric vehicles, and the like due to their high energy density, low cost, long cycle cycle-life, and safety. The development of lithium secondary batteries with high energy density and long cycle-life is attracting attention.

Lithium secondary batteries comprise four key components: a cathode, an anode, a separator, and an electrolyte. The performance of these batteries is determined by the material characteristics of these components. Recently, issues related to battery ignition and explosion in the mid-to-large battery markets, such as electric vehicles and ESS, have emerged as obstacles to market growth.

In addition, low cost, rapid charging and discharging technology, and high safety technology are essential for the commercialization of electric vehicles, and improving the performance of electrolyte solvents and additives of lithium ion batteries is being emphasized to improve battery performance and safety.

Lithium iron phosphate (LiFePO₄, LFP) cathode active materials undergo no structural changes during charging. Additionally, LFP anodes, with an olivine-based structure, demonstrate excellent thermal stability in a charged state but exhibit low electrical conductivity (2.6×10⁻⁹ S/cm, cf) LCO: ˜10⁻³ S/cm). This low electrical conductivity arises because oxygen atoms are strongly bound in a hexagonal form, which hinders the smooth migration of lithium ions.

The lithium iron phosphate (LiFePO₄, LFP) cathode active materials have excellent thermal stability, no structural changes resulting from charging, and no structural changes even when receiving heat in a charged state, due to their three-dimensional olivine structure with strong P—O covalent bonds.

In these lithium iron phosphate (LiFePO₄, LFP) cathode active materials, reducing the particle size to the nanoscale decreases the migration distance of lithium ions, which enhances the rate capability.

The capacity (theoretical capacity: 170 mAh/g for FePO₄) and voltage plateau (3.2-3.4 V level) of olivine-based anodes are low. Additionally, both electronic conductivity and ionic conductivity are low due to the material's inherent properties. In particular, the energy efficiency is significantly reduced at low temperatures.

To solve these problems, there is a need to develop an electrolyte system to improve high-temperature storage, low-temperature output characteristics, and long-term cycle-life performance of lithium secondary batteries employing lithium iron phosphate (LiFePO₄, LFP) anode active materials.

The information disclosed in this Background of the present disclosure section is only for enhancement of understanding of the general background of the present disclosure may not be taken as an acknowledgement or any form of suggestion that this information forms the related art already known to a person skilled in the art.

### SUMMARY

Various aspects of the present disclosure are directed to providing an electrolyte for a lithium secondary battery and a method for preparing the same, wherein the electrolyte improves charge output characteristics of a secondary battery, especially a secondary battery containing a lithium iron phosphate (LiFePO₄, LFP) cathode active material, by containing methyl 3,3,3-trifluoropropionate (MTFP) as a co-solvent and vinylene carbonate (VC), 1,3-propane sultone (PS), and lithium difluoro(bisoxalato) phosphate (LiDFBP) as additives.

The technical subjects pursued in the present disclosure may not be limited to the above-mentioned technical subjects, and other technical subjects which are not mentioned may be clearly understood, through the following descriptions, by those skilled in the art to which the present disclosure pertains.

In accordance with an aspect of the present disclosure, there is provided an electrolyte for a secondary battery, containing: a solvent component comprising methyl 3,3,3-trifluoropropionate (MTFP); a metal salt; and an additive.

For example, the solvent component may contain methyl 3,3,3-trifluoropropionate (MTFP), and the metal salt may include a lithium salt.

For example, the solvent component may further contain fluoroethylene carbonate (FEC).

For example, the content of methyl 3,3,3-trifluoropropionate (MTFP) may be 70 to 90 vol % relative to a total volume of 100 vol % of the electrolyte.

In certain aspects, the solvent component may be a non-aqueous organic solvent component. In such aspects, the solvent component may contain less than 20, 15, 10, 8, 7, 5, 4, 3, 2 or 0.5 volume percent water based on total volume of the solvent component, and the solvent component is comprised of a single solvent (MTFP) or an admixture of two or more distinct organic solvents. Preferred organic solvents present in the solvent components will be polar solvents and more preferably water-miscible organic solvents.

For example, the additive may include vinyl carbonate (VC).

For example, the content of vinylene carbonate (VC) may be 1.0 to 2.0 wt % relative to a total weight of 100 wt % of the electrolyte.

For example, the additive may include 1,3-propane sultone (PS).

For example, the content of 1,3-propane sultone (PS) may be 0.5 to 1.0 wt % relative to a total weight of 100 wt % of the electrolyte.

For example, the additive may include lithium difluoro(bisoxalato) phosphate (LiDFBP).

For example, the content of lithium difluoro(bisoxalato) phosphate (LiDFBP) may be 0.5 to 1.0 wt % relative to a total weight of 100 wt % of the electrolyte.

In accordance with another aspect of the present disclosure, there is provided a method for preparing an electrolyte for a secondary battery, the electrolyte being prepared by adding a lithium salt and an additive to a solvent component, wherein the solvent component contains methyl 3,3,3-trifluoropropionate (MTFP).

For example, the solvent component may further contain fluoroethylene carbonate (FEC).

For example, the methyl 3,3,3-trifluoropropionate (MTFP) may be prepared in a content of 70 to 90 vol % relative to a total volume of 100 vol % of the electrolyte.

In certain aspects, the solvent component may be a non-aqueous organic solvent component.

For example, the additive may further include vinylene carbonate.

For example, vinylene carbonate may be added in a content of 1.0 to 2.0 wt % relative to a total weight of 100 wt % of the electrolyte.

For example, the additive may further include 1,3-propane sultone (PS).

For example, 1,3-Propane sultone (PS) may be added in a content of 0.5 to 1.0 wt % relative to a total weight of 100 wt % of the electrolyte.

For example, the additive may further include lithium difluoro(bisoxalato) phosphate (LiDFBP).

For example, lithium difluoro(bisoxalato) phosphate (LiDFBP) may be added in a content of 0.5 to 1.0 wt % relative to a total weight of 100 wt % of the electrolyte.

In accordance with still another aspect of the present disclosure, there is provided a secondary battery including the electrolyte for a lithium secondary battery of the present disclosure.

In a further aspect, vehicles are provided that comprise an electrolyte as disclosed herein.

In a yet further aspect, vehicles are provided that comprise a secondary battery as disclosed herein.

The electrolyte for a lithium secondary battery of the present disclosure contains methyl 3,3,3-trifluoropropionate (MTFP) as a co-solvent and vinylene carbonate (VC), 1,3-propane sultone (PS) lithium difluoro(bisoxalato) phosphate (LiDFBP) as additives. The present disclosure can provide an electrolyte for a lithium secondary battery and a method for preparing same, the electrolyte capable of improving charge output characteristics of a secondary battery, especially a secondary battery containing a lithium iron phosphate (LiFePO₄, LFP) cathode active material.

### BRIEF DESCRIPTION OF THE DRAWINGS

The above and other aspects, features and advantages of the present disclosure will be more apparent from the following detailed description taken in conjunction with the accompanying drawings.

FIG. 1 shows a structural formula of methyl 3,3,3-trifluoropropionate (MTFP), which is a solvent contained in an electrolyte for a lithium secondary battery of the present disclosure.

FIG. 2 shows a structural formula of fluoroethylene carbonate (FEC), which is a solvent contained in an electrolyte for a lithium secondary battery of the present disclosure.

FIG. 3 shows a structural formula of lithium difluoro(bisoxalato) phosphate (LiDFBP), which is an additive contained in an electrolyte for a lithium secondary battery of the present disclosure.

FIG. 4 shows a structural formula of vinylene carbonate (VC), which is an additive contained in an electrolyte for a lithium secondary battery of the present disclosure.

FIG. 5 shows a structural formula of 1,3-propane sultone (PS), which is an additive contained in an electrolyte for a lithium secondary battery of the present disclosure.

FIG. 6 shows a graph depicting high-temperature cycle-life characteristics (capacity retention ratio) depending on the volume percentage (vol %) of methyl 3,3,3-trifluoropropionate (MTFP) in Examples 1 to 3 and Comparative Examples 4 to 7.

FIG. 7 shows a graph depicting high-temperature cycle-life characteristics (capacity retention ratio) depending on the weight percentage (wt %) of lithium difluoro(bisoxalato) phosphate (LiDFBP) in Examples and 2 and 4 to 8 and Comparative Examples 8 to 25.

FIG. 8 shows a graph depicting room-temperature output performance (capacity retention ratio) depending on the volume percentage (vol %) of methyl 3,3,3-trifluoropropionate (MTFP) in Examples 1 and 3 and Comparative Examples 4 to 7.

FIG. 9 shows a graph depicting room-temperature output characteristics (capacity retention ratio) depending on the weight percentage (wt %) of lithium difluoro(bisoxalato) phosphate (LiDFBP) in Examples and 2 and 4 to 8 and Comparative Examples 8 to 25.

### DETAILED DESCRIPTION OF THE EXEMPLARY EMBODIMENTS

The terms and words used in this description and the appended claims are not to be interpreted in common or lexical meaning but, based on the principle that an inventor can adequately define the meanings of terms to best describe the disclosure, to be interpreted in the meaning and concept conforming to the technical concept of the present disclosure.

The terms used herein are merely used to describe exemplary embodiments, and are not intended to limit the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The present disclosure is directed to an electrolyte for a lithium secondary battery and a method for preparing the same, wherein the electrolyte improves charge output characteristics of a secondary battery, especially a secondary battery containing a lithium iron phosphate (LiFePO₄, LFP) cathode active material, by containing methyl 3,3,3-trifluoropropionate (MTFP) and fluoroethylene carbonate (FEC) as co-solvents and vinylene carbonate (VC), 1,3-propane sultone (PS), and lithium difluoro(bisoxalato) phosphate (LiDFBP) as additives.

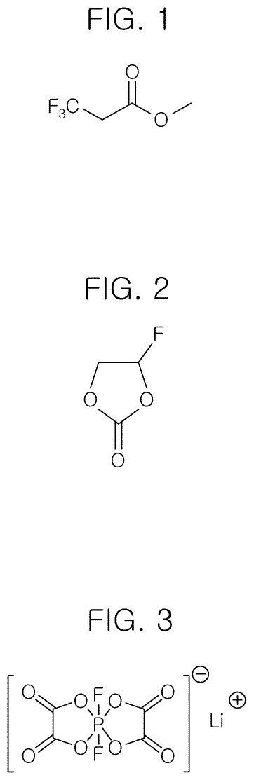

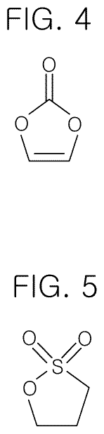

FIG. 1 shows a structural formula of methyl 3,3,3-trifluoropropionate (MTFP), which is a solvent contained in an electrolyte for a lithium secondary battery of the present disclosure; FIG. 2 shows a structural formula of fluoroethylene carbonate (FEC), which is a solvent contained in an electrolyte for a lithium secondary battery of the present disclosure; FIG. 3 shows a structural formula of lithium difluoro(bisoxalato) phosphate (LiDFBP), which is an additive contained in an electrolyte for a lithium secondary battery of the present disclosure; FIG. 4 shows a structural formula of vinylene carbonate (VC), which is an additive contained in an electrolyte for a lithium secondary battery of the present disclosure; and FIG. 5 shows a structural formula of 1,3-propane sultone (PS), which is an additive contained in an electrolyte for a lithium secondary battery of the present disclosure.

The electrolyte for a secondary battery of the present disclosure will be described with reference to the drawings.

Methyl 3,3,3-trifluoropropionate (MTFP), a fluorinated solvent, typically exhibits a lower HOMO energy level, leading to an enhanced oxidation resistance and a higher boiling point (BP) in an electrolyte. Consequently, this can improve the cycle-life characteristics of the battery.

A cathode of the battery is modified with an F-rich SEI layer, thereby reducing side effects at the cathode through high oxidation resistance of a fluorinated solvent, leading to an improvement in cycle-life characteristics of the battery. At an anode, the reactivity of reduction and the formation of F-rich SEI, based on low LUMO, can protect the anode and improve the cycle-life characteristics.

Meanwhile, the CF₃ functional group, acting as a strong electron withdrawing group (EWG), may cause electron density delocalization within the methyl 3,3,3-trifluoropropionate (MTFP) molecule, facilitating the de-solvation of lithium ions, thereby enhancing charge/discharge rate capability of the battery.

Fluoroethylene carbonate (FEC), a fluorinated solvent, enables the formation of a protective layer on the anode surface. When used as a solvent for an electrolyte along with methyl 3,3,3-trifluoropropionate (MTFP), the fluoroethylene carbonate can improve cycle-life characteristics, enhance charge/discharge rate capability, and prevent the precipitation of lithium salt.

Meanwhile, this may be added to the solvent methyl 3,3,3-trifluoropropionate (MTFP), and may be used in combination with additives to enhance the cycle-life performance.

The additive lithium difluoro(bisoxalato) phosphate (LiDFBP) is quickly decomposed at the early stage during charge, to thereby form a stable film on the cathode and anode surfaces, thus suppressing the initial decomposition of the fluorinated solvents.

Compared to using LiDFBP alone, the combined use of vinylene carbonate (VC) and 1,3-propane sultone (PS)—both capable of forming an SEI layer as a protective layer on the cathode and anode surfaces—can exhibit superior performance.

Specifically, the electrolyte for a secondary battery of the present disclosure may contain: a solvent component containing methyl 3,3,3-trifluoropropionate (MTFP); a metal salt; and an additive.

The metal salt may include a lithium salt, and the electrolyte for a secondary battery of the present disclosure may be used as an electrolyte for a lithium secondary battery.

The solvent component may further contain fluoroethylene carbonate (FEC). As can be verified in the examples and comparative examples to be described later, the further containing of fluoroethylene carbonate (FEC) can increase the solubility of a metal salt such as a lithium salt and improve high-temperature cycle-life characteristics (capacity retention ratio) and room-temperature output performance compared to the use of methyl 3,3,3-trifluoropropionate (MTFP) alone.

In certain aspects, the solvent component may be a non-aqueous organic solvent component. As discussed, In certain aspects, the solvent component may be a non-aqueous organic solvent component. In such aspects, the solvent component may contain less than 20, 15, 10, 8, 7, 5, 4, 3, 2 or 0.5 volume percent water based on total volume of the solvent component, and the solvent component is comprised of a single solvent (MTFP) or an admixture of two or more distinct organic solvents. Preferred organic solvents present in the solvent components will be polar solvents and more preferably water-miscible organic solvents.

Meanwhile, relative to a total volume of 100 vol % of the electrolyte, the content of methyl 3,3,3-trifluoropropionate (MTFP) may be 70 to 90 vol %, preferably 75 to 85 vol %, and more preferably 80 vol %.

As can be verified in the examples and comparative examples to be described later, methyl 3,3,3-trifluoropropionate (MTFP), when used with a volume within the corresponding vol % range, may exhibit effects of increasing the solubility of a metal salt such as a lithium salt and improving high-temperature cycle-life characteristics (capacity retention ratio) and room-temperature output performance. When methyl 3,3,3-trifluoropropionate (MTFP) is used in volumes below the corresponding range, it may reduce high-temperature cycle-life characteristics and room-temperature output performance. Conversely, exceeding the corresponding range may further compromise high-temperature cycle-life characteristics, room-temperature output performance, and solubility.

In the electrolyte for a secondary battery, the volume ratio of methyl 3,3,3-trifluoropropionate (MTFP) and fluoroethylene carbonate (FEC) may be 7:3 to 9:1, preferably 7.5:2.5 to 8.5:1.5, and more preferably 8:2.

As can be verified in the examples, comparative examples, and experimental examples to be described later, methyl 3,3,3-trifluoropropionate (MTFP), when used at a volume proportion within the corresponding volume ratio range, may exhibit effects of increasing the solubility of a metal salt such as a lithium salt and improving high-temperature cycle-life characteristics (capacity retention ratio) and room-temperature output performance. Whereas, methyl 3,3,3-trifluoropropionate (MTFP), when used at a volume proportion below the corresponding volume ratio range (e.g., MTFP:FEC=6:4), may reduce high-temperature cycle-life characteristics and room-temperature output performance, and methyl 3,3,3-trifluoropropionate (MTFP), when used in a volume proportion exceeding the corresponding volume ratio range (e.g., MTFP:FEC=4:6), may reduce high-temperature cycle-life characteristics, room-temperature output performance, and solubility.

The electrolyte for a secondary battery of the present disclosure may contain lithium difluoro(bisoxalato) phosphate (LiDFBP) as an additive.

The content of lithium difluoro(bisoxalato) phosphate (LiDFBP) may be 0.5 to 1.0 wt % relative to a total weight of 100 wt % of the electrolyte.

As can be verified in the examples, comparative examples, and experimental examples to be described later, lithium difluoro(bisoxalato) phosphate (LiDFBP), when used in a content within the corresponding range, may exhibit effects of improving high-temperature cycle-life characteristics (capacity retention ratio) and room-temperature output performance. Whereas, lithium difluoro(bisoxalato) phosphate, when used in a content below or exceeding the corresponding range, may reduce ON cycle-life characteristics and room-temperature output performance.

Meanwhile, the electrolyte for a secondary battery of the present disclosure may contain vinylene carbonate (VC) as an additive.

The content of vinylene carbonate (VC) may be 1.0 to 2.0 wt % relative to a total weight of 100 wt % of the electrolyte.

As demonstrated in the forthcoming examples, including comparative examples and experimental data, vinylene carbonate (VC), used with the corresponding range, may exhibit effects of improving high-temperature cycle-life characteristics (capacity retention ratio) and room-temperature output performance. However, when vinylene carbonate (VC) is used below or exceeds the corresponding range, it may reduce the ON cycle-life characteristic and room-temperature output performance.

In addition, the electrolyte for a secondary battery of the present disclosure may contain 1,3-propane sultone (PS) as an additive.

The content of 1,3-propane sultone (PS) may be 0.5 to 1.0 wt % relative to a total weight of 100 wt % of the electrolyte.

As can be verified in the examples, comparative examples, and experimental examples to be described later, 1,3-propane sultone (PS), when used in a content within the corresponding range, may exhibit effects of improving high-temperature cycle-life characteristics (capacity retention ratio) and room-temperature output performance. Whereas, 1,3-propane sultone (PS), when used in a content below or exceeding the corresponding range, may reduce the ON cycle-life characteristic and room-temperature output performance.

In the method for preparing an electrolyte for a secondary battery of the present disclosure, the electrolyte may be prepared by adding a lithium salt and an additive to a solvent component, wherein the solvent component may contain methyl 3,3,3-trifluoropropionate (MTFP).

The solvent component may further contain fluoroethylene carbonate (FEC).

The content of methyl 3,3,3-trifluoropropionate (MTFP) may be 70 to 90 vol %, preferably 75 to 85 vol %, and more preferably 80 vol %, relative to a total weight of 100 vol % of the electrolyte. In the electrolyte for a secondary battery, the volume ratio of methyl 3,3,3-trifluoropropionate (MTFP) and fluoroethylene carbonate (FEC) may be 7:3 to 9:1, preferably 7.5:2.5 to 8.5:1.5, and more preferably 8:2.

As described above, the volume ratio within the corresponding ranges may exhibit effects of increasing the solubility of a metal salt such as a lithium salt and improving high-temperature cycle-life characteristics (capacity retention ratio), and room-temperature output performance.

In the method for preparing an electrolyte for a secondary battery of the present disclosure, the additive may further include lithium difluoro(bisoxalato) phosphate (LiDFBP).

Specifically, lithium difluoro(bisoxalato) phosphate (LiDFBP) may be added in a content of 0.5 to 1.0 wt % relative to a total weight of 100 wt % of the electrolyte.

As can be verified in the examples, comparative examples, and experimental examples to be described later, lithium difluoro(bisoxalato) phosphate (LiDFBP), when used in a content within the corresponding range, may exhibit effects of improving high-temperature cycle-life characteristics (capacity retention ratio) and room-temperature output performance. However, lithium difluoro(bisoxalato) phosphate (LiDFBP), when used in a content below or exceeding the corresponding range, may reduce the ON cycle-life characteristic and room-temperature output performance.

In the method for preparing an electrolyte for a secondary battery of the present disclosure, the additive may further include 1,3-propane sultone (PS).

Specifically, vinylene carbonate may be added in a content of 0.5 to 1.0 wt % relative to a total weight of 100 wt % of the electrolyte.

As can be verified in the examples, comparative examples, and experimental examples to be described later, 1,3-propane sultone (PS), when used in a content within the corresponding range, may exhibit effects of improving high-temperature cycle-life characteristics (capacity retention ratio) and room-temperature output performance. Whereas, 1,3-propane sultone (PS), when used in a content below or exceeding the corresponding range, may reduce the ON cycle-life characteristic and room-temperature output performance.

Furthermore, the secondary battery of the present disclosure may contain the above-described electrolyte for a secondary battery of the present disclosure.

Hereinafter, an electrolyte, a cathode, an anode, and a separator, which are basic elements of the secondary battery will be described.

In the electrolyte for a lithium secondary battery of the present disclosure, any lithium salt that is commonly used for an electrolyte for a lithium secondary battery may be used without limitation as a lithium salt contained in the electrolyte.

For example, the lithium salt may contain Li⁺ as a cation and, as an anion, at least one selected from the group consisting of F, Cl, Br, I, NO₃, N(CN)₂, BF₄, ClO₄, AlO₄, AlCl₄, PF₆, SbF₆, AsF₆, BF₂C₂O₄⁻, BC₄O₈⁻, PO₂F₂⁻, PF₄C₂O₄⁻, PF₂C₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN, and (CF₃CF₂SO₂)₂N⁻.

Meanwhile, the concentration of the lithium salt may be adjusted within the commonly usable range. However, to achieve an optimal effect in the formation of a film for preventing the corrosion of the electrode surface, the lithium salt may be contained at a concentration of 0.8 M to 3.0 M, specifically 1.0 M to 3.0 M in the electrolyte. When the concentration of the lithium salt is below 0.8 M, the conductivity of the electrolyte may be decreased and thus the performance of the electrolyte may deteriorate. When the concentration of the lithium salt exceeds 3.0 M, the viscosity of the electrolyte may be increased to reduce the mobility of lithium ions and degrade the wettability of the electrolyte.

The solvent component serves as a medium, through which ions involved in the electrochemical reaction of the battery can move. In the solvent component, any or a wide variety of organic solvent may be used without limitation as long as it can be minimally decomposed by oxidation reactions and the like during charge/discharge of the secondary battery and can exhibit desired properties along with additives.

Specifically, for the solvent component, a carbonate-based, ester-based, ether-based, ketone-based, alcohol-based, or aprotic solvent may be used alone or in a combination of two or more.

In the solvents, the carbonate-based solvent may employ at least one solvent selected from the group consisting of dimethyl carbonate (DMC), diethyl carbonate (DEC), dipropyl carbonate (DPC), methylpropyl carbonate (MPC), ethylpropyl carbonate (EPC), and methylethyl carbonate. (MEC), ethylene carbonate (EC), propylene carbonate (PC), butylene carbonate (BC), and a mixture thereof.

The ester-based solvent may employ at least one solvent selected from the group consisting of methyl acetate, ethyl acetate, n-propyl acetate, dimethyl acetate, methyl propionate, ethyl propionate, propyl propionate, decanolide, mevalonolactone, caprolactone, and a mixture thereof.

The ether-based solvent may employ at least one solvent selected from the group consisting of dimethyl ether, diethyl ether, dipropyl ether, methyl ethyl ether, methyl propyl ether and ethyl propyl ether, dibutyl ether, tetraglyme, diglyme, dimethoxyethane, 2-methyl tetrahydrofuran, tetrahydrofuran, and a mixture thereof.

The ketone-based solvent may employ cyclohexanone and the like.

The alcohol-based solvent may employ at least one solvent selected from the group consisting of ethyl alcohol, isopropyl alcohol, and a mixture thereof.

The aprotic solvent may employ at least one solvent selected from the group consisting of nitriles (such as R—CN where R is a C2 to C20 linear, branched, or cyclic hydrocarbon-based moiety and may include a double bond, an aromatic ring, or an ether bond), amides such as dimethylformamide, dioxolanes such as 1,3-dioxolane, and sulfolane may be used.

The organic solvents may be used alone or in a mix of one or more. When one or more organic solvents are used, the mixing ratio may be adjusted to achieve the desired battery performance. This mixing ratio is typically comprehensible to a person skilled in the art.

Alternatively, the organic solvent may be at least one solvent selected from the group consisting of a high-dielectric solvent and a low-boiling point solvent.

Specifically, the high dielectric solvent is not particularly limited as long as it is commonly used in the art, and examples thereof may include cyclic carbonates such as ethylene fluoride carbonate, ethylene carbonate, propylene carbonate, butylene carbonate, and 1-fluoroethylene carbonate, gamma-butyrolactone, and a mixture thereof.

Examples of the low-boiling point solvent may employ chain carbonates such as dimethyl carbonate, ethylmethyl carbonate, diethyl carbonate, and dipropyl carbonate, dimethoxyethane, diethoxyethane, fatty acid ether derivatives, and a mixture thereof.

The organic solvent may be contained as a remainder to satisfy a total of 100 wt % of the electrolyte for a lithium secondary battery.

### <Cathode>

A cathode material may be obtained by mixing a cathode active material, a conductive material, and a binder. The conductive material may be a carbon material, such as natural graphite, artificial graphite, cokes, carbon black, carbon nanotubes, or graphene. The binder may include a thermoplastic resin, for example, a fluorine resin, such as polyvinylidene fluoride, polytetrafluoroethylene, tetrafluoroethylene, a vinylidene fluoride-based copolymer, or hexafluoropropylene, and/or a polyolefin resin, such as polyethylene or polypropylene.

The cathode material may be applied onto a cathode current collector to form a cathode. The cathode current collector may be a conductor, such as Al, Ni, or stainless steel. Application methods include pressure molding; or a method of preparing a paste using an organic solvent, applying the paste onto the current collector, and fixing the paste by pressing. The organic solvent may include: amine solvents such as N,N-dimethylaminopropylamine and diethylenetriamine; ether solvents such as ethylene oxide and tetrahydrofuran; ketone solvents such as methyl ethyl ketone; ester solvents such as methyl acetate; aprotic polar solvents such as dimethylacetamide and N-methyl-2-pyrrolidone; and the like. The application of the paste onto the cathode current collector may be performed by using, for example, gravure coating, slit dye coating, knife coating, or spray coating.

### <Anode>

An anode active material may be formed using a metal, a metal alloy, a metal oxide, a metal fluoride, a metal sulfide, or a carbon material, such as natural graphite, artificial graphite, cokes, carbon black, carbon nanotubes, or graphene, in which the intercalation and de-intercalation of lithium ions or a conversion reaction may occur.

An anode material may be obtained by mixing the anode active material, a conductive material, and a binder. The conductive material may be a carbon material, such as natural graphite, artificial graphite, cokes, carbon black, carbon nanotubes, or graphene. The binder may include a thermoplastic resin, for example, a fluorine resin, such as polyvinylidene fluoride, polytetrafluoroethylene, tetrafluoroethylene, a vinylidene fluoride-based copolymer, or hexafluoropropylene, and/or a polyolefin resin, such as polyethylene or polypropylene.

The anode material may be applied onto an anode current collector to form an anode. The cathode current collector may be a conductor, such as Al, Ni, or stainless steel. Application methods include pressure molding; or a method of preparing a paste using an organic solvent, applying the paste onto the current collector, and fixing the paste by pressing. The organic solvent may include: amine solvents such as N,N-dimethylaminopropylamine and diethylenetriamine; ether solvents such as ethylene oxide and tetrahydrofuran; ketone solvents such as methyl ethyl ketone; ester solvents such as methyl acetate; aprotic polar solvents such as dimethylacetamide and N-methyl-2-pyrrolidone; and the like. The application of the paste onto the anode collector may be performed by using, for example, gravure coating, slit dye coating, knife coating, or spray coating.

### <Electrolyte>

An electrolyte may contain a lithium salt. The lithium salt may be lithium perchlorate (LiClO₄), lithium tetrafluoroborate (LiBF₄), lithium hexafluorophosphate (LiPF₆), lithium trifluoromethane sulfonate (LiCF₃SO₃), lithium hexafluoroacetate (LiAsF₆), lithium trifluoromethanesulfonylimide (Li(CF₃SO₂)₂N), or a mixture of two or more thereof. Of these, an electrolyte containing fluorine may be used. Alternatively, the electrolyte may be used as a non-aqueous electrolyte by dissolving in an organic solvent. Examples of the organic solvent may include: carbonates, such as propylene carbonate, ethylene carbonate, dimethyl carbonate, diethyl carbonate, ethyl methyl carbonate, isopropyl methyl carbonate, vinylene carbonate, 4-trifluoromethyl-1,3-dioxolan-2-one, and 1,2-di(methoxycarbonyloxy)ethane; ethers, such as 1,2-dimethoxyethane, 1,3-dimethoxypropane, pentafluoropropylmethyl ether, 2,2,3,3-tetrafluoropropyldifluoromethyl ether, tetrahydrofuran, and 2-methyltetrahydrofuran; esters, such as methyl formate, methyl acetate, and γ-butyrolactone; nitriles, such as acetonitrile and butyronitrile; amides, such as N,N-dimethylformamide and N,N-dimethylacetamide; carbamates such as 3-methyl-2-oxazolidone; sulfur-containing compounds, such as sulfolane, dimethyl sulfoxide, and 1,3-propane sultone; or ones obtained by introducing an additional fluorine substituent into the above-mentioned organic solvents.

Alternatively, a solid electrolyte may be used. The solid electrolyte may be an organic solid electrolyte, such as a polyethylene oxide-based polymer compound or a polymer compound containing at least one of a polyorganosiloxane chain or a polyoxyalkylene chain. Alternatively, so-called gel-type electrolyte in which a non-aqueous electrolyte is supported on a polymer compound. Meanwhile, an inorganic solid electrolyte may be used. The use of these solid electrolytes can further improve the safety of a sodium secondary battery. In addition, the solid electrolyte may serve as a separator, and in that case, a separator may not be needed.

### <Separator>

A separator may be disposed between the cathode and the anode. This separator may be a material in the form of a porous film, non-woven fabric, or woven fabric formed of a polyolefin resin, such as polyethylene or polypropylene, a fluorine resin, or a nitrogen-containing aromatic polymer. The thickness of the separator is preferably thinner as long as the mechanical strength of the separator is maintained, considering an increased volume energy density of the battery and a reduced inner resistance. The thickness of the separator may be typically 5 to 200 μm, more specifically, 5 to 40 μm.

### <Method for Manufacturing Alkali Metal Secondary Battery>

A secondary battery may be manufactured by sequentially stacking a cathode, a separator, and an anode to form an electrode group, followed by rolling the electrode group, if needed, accommodating the electrode group into a battery can, and impregnating the electrode group with the electrolyte. Alternatively, a secondary battery may be manufactured by stacking a cathode, a solid electrolyte, and an anode to form an electrode group, rolling the electrode group, if needed, and accommodating the electrode group in a battery can.

Hereinafter, preferable examples will be set forth for better understanding of the present disclosure. However, the following experimental examples are provided to help in understanding the present disclosure, and the present disclosure is not limited to the following experimental examples.

### Examples and Comparative Examples

### Example 1

A lithium secondary battery was manufactured by using a cathode containing LiFePO₄ (LFP) as a cathode active material, an anode containing graphite as an anode active material, and an electrolyte. The electrolyte was prepared by adding 1.15 M LiPF₆ to a mixture solvent in which the volume ratio of methyl 3,3,3-trifluoropropionate (MTFP) and fluoroethylene carbonate (FEC) is 10:90.

### Example 2

A lithium secondary battery was prepared by the same method as in Example 1 except that the volume ratio of methyl 3,3,3-trifluoropropionate (MTFP) and fluoroethylene carbonate (FEC) is 20:80.

### Example 3

A lithium secondary battery was prepared by the same method as in Example 1 except that the volume ratio of methyl 3,3,3-trifluoropropionate (MTFP) and fluoroethylene carbonate (FEC) is 30:70.

### Example 4

A lithium secondary battery was prepared by the same method as in Example 1 except that the volume ratio of methyl 3,3,3-trifluoropropionate (MTFP) and fluoroethylene carbonate (FEC) is 20:80 and, additionally, 1.0 wt % of vinylene carbonate (VC), 1.0 wt % of 1,3-propane sultone (PS), and 1.0 wt % of lithium difluoro(bisoxalato) phosphate (LiDFBP) were introduced to the electrolyte.

### Example 5

A lithium secondary battery was prepared by the same method as in Example 1 except that the volume ratio of methyl 3,3,3-trifluoropropionate (MTFP) and fluoroethylene carbonate (FEC) is 20:80 and, additionally, 2.0 wt % of vinylene carbonate (VC), 1.0 wt % of 1,3-propane sultone (PS), and 0.5 wt % of lithium difluoro(bisoxalato) phosphate (LiDFBP) were introduced to the electrolyte.

### Example 6

A lithium secondary battery was prepared by the same method as in Example 1 except that the volume ratio of methyl 3,3,3-trifluoropropionate (MTFP) and fluoroethylene carbonate (FEC) is 20:80 and, additionally, 2.0 wt % of vinylene carbonate (VC), 1.0 wt % of 1,3-propane sultone (PS), and 1.0 wt % of lithium difluoro(bisoxalato) phosphate (LiDFBP) were introduced to the electrolyte.

### Example 7

A lithium secondary battery was prepared by the same method as in Example 1 except that the volume ratio of methyl 3,3,3-trifluoropropionate (MTFP) and fluoroethylene carbonate (FEC) is 20:80 and, additionally, 2.0 wt % of vinylene carbonate (VC), 0.5 wt % of 1,3-propane sultone (PS), and 0.5 wt % of lithium difluoro(bisoxalato) phosphate (LiDFBP) were additionally introduced to the electrolyte.

### Example 8

A lithium secondary battery was prepared by the same method as in Example 1 except that the volume ratio of methyl 3,3,3-trifluoropropionate (MTFP) and fluoroethylene carbonate (FEC) is 20:80 and 2.0 wt % of vinylene carbonate (VC), 0.5 wt % of 1,3-propane sultone (PS), and 1.0 wt % of lithium difluoro(bisoxalato) phosphate (LiDFBP) were additionally introduced to the electrolyte.

### Comparative Example 1

A lithium secondary battery was manufactured by using a cathode containing LiFePO₄ (LFP) as a cathode active material, an anode containing graphite as an anode active material, and an electrolyte.

For the electrolyte, a non-aqueous organic solvent was prepared by adding 1.15 M LiPF₆ to a mixture solvent in which the volume ratio of ethylene carbonate (EC), ethyl methyl carbonate (EMC), and dimethyl carbonate (DMC) was 30:60:10.

### Comparative Example 2

A lithium secondary battery was prepared by the same method as in Comparative Example 1 except that 2.0 wt % of vinylene carbonate (VC), 1.0 wt % of 1,3-propane sultone (PS), 1.0 wt % of lithium difluoro(bisoxalato) phosphate (LiDFBP) were additionally introduced to the electrolyte.

### Comparative Example 3

A lithium secondary battery was manufactured by using a cathode containing LiFePO₄ (LFP) as a cathode active material, an anode containing graphite as an anode active material, and an electrolyte.

The electrolyte was prepared by adding 1.15 M LiPF₆ to a mixture solvent in which the volume ratio of methyl 3,3,3-trifluoropropionate (MTFP) and fluoroethylene carbonate (FEC) is 100:0.

### Comparative Example 4

A lithium secondary battery was manufactured by using a cathode containing LiFePO₄ (LFP) as a cathode active material, an anode containing graphite as an anode active material, and an electrolyte.

The electrolyte was prepared by adding 1.15 M LiPF₆ to a mixture solvent in which the volume ratio of methyl 3,3,3-trifluoropropionate (MTFP) and fluoroethylene carbonate (FEC) is 40:60.

### Comparative Example 5

A lithium secondary battery was manufactured by using a cathode containing LiFePO₄ (LFP) as a cathode active material, an anode containing graphite as an anode active material, and an electrolyte.

The electrolyte was prepared by adding 1.15 M LiPF₆ to a mixture solvent in which the volume ratio of methyl 3,3,3-trifluoropropionate (MTFP) and fluoroethylene carbonate (FEC) is 50:50.

### Comparative Example 6

A lithium secondary battery was manufactured by using a cathode containing LiFePO₄ (LFP) as a cathode active material, an anode containing graphite as an anode active material, and an electrolyte.

The electrolyte was prepared by adding 1.15 M LiPF₆ to a mixture solvent in which the volume ratio of methyl 3,3,3-trifluoropropionate (MTFP) and fluoroethylene carbonate (FEC) is 60:40.

### Comparative Example 7

A lithium secondary battery was manufactured by using a cathode containing LiFePO₄ (LFP) as a cathode active material, an anode containing graphite as an anode active material, and an electrolyte.

The electrolyte was prepared by adding 1.15 M LiPF₆ to a mixture solvent in which the volume ratio of methyl 3,3,3-trifluoropropionate (MTFP) and fluoroethylene carbonate (FEC) is 70:30.

### Comparative Example 8

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 0.0 wt % of vinylene carbonate (VC), 0.0 wt % of 1,3-propane sultone (PS), and 0.5 wt % of lithium difluoro(bisoxalato) phosphate (LiDFBP) were introduced to the electrolyte.

### Comparative Example 9

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 0.0 wt % of vinylene carbonate (VC), 0.0 wt % of 1,3-propane sultone (PS), and 1.0 wt % of lithium difluoro(bisoxalato) phosphate (LiDFBP) were introduced to the electrolyte.

### Comparative Example 10

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 0.0 wt % of vinylene carbonate (VC), 0.0 wt % of 1,3-propane sultone (PS), and 1.5 wt % of lithium difluoro(bisoxalato) phosphate (LiDFBP) were introduced to the electrolyte.

### Comparative Example 11

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 1.0 wt % of vinylene carbonate (VC), 1.0 wt % of 1,3-propane sultone (PS), and 0.0 wt % of lithium difluoro(bisoxalato) phosphate (LiDFBP) were introduced to the electrolyte.

### Comparative Example 12

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 1.0 wt % of vinylene carbonate (VC), 1.0 wt % of 1,3-propane sultone (PS), and 0.5 wt % of lithium difluoro(bisoxalato) phosphate (LiDFBP) were introduced to the electrolyte.

### Comparative Example 13

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 1.0 wt % of vinylene carbonate (VC), 1.0 wt % of 1,3-propane sultone (PS), and 1.5 wt % of lithium difluoro(bisoxalato) phosphate (LiDFBP) were introduced to the electrolyte.

### Comparative Example 14

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 2.0 wt % of vinylene carbonate (VC), 1.0 wt % of 1,3-propane sultone (PS), and 0.0 wt % of lithium difluoro(bisoxalato) phosphate (LiDFBP) were additionally introduced to the electrolyte.

### Comparative Example 15

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 2.0 wt % of vinylene carbonate (VC), 1.0 wt % of 1,3-propane sultone (PS), and 1.5 wt % of lithium difluoro(bisoxalato) phosphate (LiDFBP) were introduced to the electrolyte.

### Comparative Example 16

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 2.5 wt % of vinylene carbonate (VC), 1.0 wt % of 1,3-propane sultone (PS), and 0.0 wt % of lithium difluoro(bisoxalato) phosphate (LiDFBP) were additionally introduced to the electrolyte.

### Comparative Example 17

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 2.5 wt % of vinylene carbonate (VC), 1.0 wt % of 1,3-propane sultone (PS), and 0.5 wt % of lithium difluoro(bisoxalato) phosphate (LiDFBP) were introduced to the electrolyte.

### Comparative Example 18

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 2.5 wt % of vinylene carbonate (VC), 1.0 wt % of 1,3-propane sultone (PS), and 1.0 wt % of lithium difluoro(bisoxalato) phosphate (LiDFBP) were introduced to the electrolyte.

### Comparative Example 19

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 2.5 wt % of vinylene carbonate (VC), 1.0 wt % of 1,3-propane sultone (PS), and 1.5 wt % of lithium difluoro(bisoxalato) phosphate (LiDFBP) were introduced to the electrolyte.

### Comparative Example 20

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 2.5 wt % of vinylene carbonate (VC), 0.5 wt % of 1,3-propane sultone (PS), and 0.0 wt % of lithium difluoro(bisoxalato) phosphate (LiDFBP) were introduced to the electrolyte.

### Comparative Example 21

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 2.5 wt % of vinylene carbonate (VC), 0.5 wt % of 1,3-propane sultone (PS), and 0.5 wt % of lithium difluoro(bisoxalato) phosphate (LiDFBP) were introduced to the electrolyte.

### Comparative Example 22

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 2.0 wt % of vinylene carbonate (VC), 1.5 wt % of 1,3-propane sultone (PS), and 0.0 wt % of lithium difluoro(bisoxalato) phosphate (LiDFBP) were additionally introduced to the electrolyte.

### Comparative Example 23

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 2.0 wt % of vinylene carbonate (VC), 1.5 wt % of 1,3-propane sultone (PS), and 0.5 wt % of lithium difluoro(bisoxalato) phosphate (LiDFBP) were additionally introduced to the electrolyte.

### Comparative Example 24

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 2.0 wt % of vinylene carbonate (VC), 1.5 wt % of 1,3-propane sultone (PS), and 1.0 wt % of lithium difluoro(bisoxalato) phosphate (LiDFBP) were additionally introduced to the electrolyte.

### Comparative Example 25

A lithium secondary battery was prepared by the same method as in Comparative Example 1 except that the volume ratio of methyl 3,3,3-trifluoropropionate (MTFP) and fluoroethylene carbonate (FEC) is 20:80 and, additionally, 2.0 wt % of vinylene carbonate (VC), 1.5 wt % of 1,3-propane sultone (PS), and 1.5 wt % of lithium difluoro(bisoxalato) phosphate (LiDFBP) were additionally introduced to the electrolyte.

TABLE 1

| | | | | | | Capacity | Output |
|---|---|---|---|---|---|---|---|
| | Solvent (vol %) | | Additive (wt %) | | | retention (%) | performance (%) |
| | FEC | MTFP | VC | PS | LiDFBP | @200 cyc | @4 C |
| Comparative | — | — | — | — | — | 82.4 | 73.0 |
| Example 1 | | | | | | | |
| Comparative | — | — | 2.0 | 1.0 | — | 85.5 | 79.7 |
| Example 2 | | | | | | | |
| Comparative | — | 100 | — | — | — | Electrolyte | |
| Example 3 | | | | | | preparation impossible | |
| Example 1 | 10 | 90 | — | — | — | 83.3 | 89.2 |
| Example 2 | 20 | 80 | — | — | — | 83.9 | 90.1 |
| Example 3 | 30 | 70 | — | — | — | 83.5 | 87.0 |
| Comparative | 40 | 60 | — | — | — | 82.2 | 79.2 |
| Example 4 | | | | | | | |
| Comparative | 50 | 50 | — | — | — | 78.1 | 71.9 |
| Example 5 | | | | | | | |
| Comparative | 60 | 40 | — | — | — | 68.4 | 60.2 |
| Example 6 | | | | | | | |
| Comparative | 70 | 30 | — | — | — | 55.9 | 55.2 |
| Example 7 | | | | | | | |
| Example 2 | 20 | 80 | — | — | — | 83.9 | 90.1 |
| Comparative | 20 | 80 | — | — | 0.5 | 84.3 | 90.6 |
| Example 8 | | | | | | | |
| Comparative | 20 | 80 | — | — | 1.0 | 84.7 | 89.4 |
| Example 9 | | | | | | | |
| Comparative | 20 | 80 | — | — | 1.5 | 82.1 | 85.3 |
| Example 10 | | | | | | | |
| Comparative | 20 | 80 | 1.0 | 1.0 | — | 84.4 | 84.3 |
| Example 11 | | | | | | | |
| Comparative | 20 | 80 | 1.0 | 1.0 | 0.5 | 85.1 | 85.1 |
| Example 12 | | | | | | | |
| Example 4 | 20 | 80 | 1.0 | 1.0 | 1.0 | 85.9 | 84.9 |
| Comparative | 20 | 80 | 1.0 | 1.0 | 1.5 | 84.1 | 81.2 |
| Example 13 | | | | | | | |
| Comparative | 20 | 80 | 2.0 | 1.0 | — | 82.8 | 83.6 |
| Example 14 | | | | | | | |
| Example 5 | 20 | 80 | 2.0 | 1.0 | 0.5 | 85.9 | 85.4 |
| Example 6 | 20 | 80 | 2.0 | 1.0 | 1.0 | 86.8 | 86.8 |
| Comparative | 20 | 80 | 2.0 | 1.0 | 1.5 | 84.5 | 82.1 |
| Example 15 | | | | | | | |
| Comparative | 20 | 80 | 2.5 | 1.0 | — | 81.4 | 76.1 |
| Example 16 | | | | | | | |
| Comparative | 20 | 80 | 2.5 | 1.0 | 0.5 | 82.6 | 77.9 |
| Example 17 | | | | | | | |
| Comparative | 20 | 80 | 2.5 | 1.0 | 1.0 | 84.5 | 76.3 |
| Example 18 | | | | | | | |
| Comparative | 20 | 80 | 2.5 | 1.0 | 1.5 | 80.1 | 72.1 |
| Example 19 | | | | | | | |
| Comparative | 20 | 80 | 2.0 | 0.5 | — | 83.9 | 84.1 |
| Example 20 | | | | | | | |
| Example 7 | 20 | 80 | 2.0 | 0.5 | 0.5 | 85.4 | 85.3 |
| Example 8 | 20 | 80 | 2.0 | 0.5 | 1.0 | 86.1 | 82.9 |
| Comparative | 20 | 80 | 2.0 | 0.5 | 1.5 | 83.1 | 80.1 |
| Example 21 | | | | | | | |
| Comparative | 20 | 80 | 2.0 | 1.5 | — | 81.7 | 80.3 |
| Example 22 | | | | | | | |
| Comparative | 20 | 80 | 2.0 | 1.5 | 0.5 | 82.3 | 81.2 |
| Example 23 | | | | | | | |
| Comparative | 20 | 80 | 2.0 | 1.5 | 1.0 | 83.9 | 78.9 |
| Example 24 | | | | | | | |
| Comparative | 20 | 80 | 2.0 | 1.5 | 1.5 | 79.1 | 76.5 |
| Example 25 | | | | | | | |

### Experimental Examples

### (1) Evaluation of High-Temperature Cycle-Life Characteristics (Capacity Retention Ratio)

The batteries manufactured in Examples 1 to 7 and Comparative Examples 1 to 33 were charged and discharged using CC-CV charging, and their discharge capacities were compared.

Specifically, each of the batteries was charged and discharged for 200 cycles with a C-rate of 1.0 C at 45° C., and the discharge capacity was measured at each cycle.

The cycle-life capacity retention ratio was obtained using Equation 1 below.

$$Cycle - life capacity retention ( \% ) = ( Discharge capacity after 200 charge / discharge \text{cycles/} Initial discharge capacity after 1 charge / discharge cycle ) \qquad [ Equation 1 ]$$

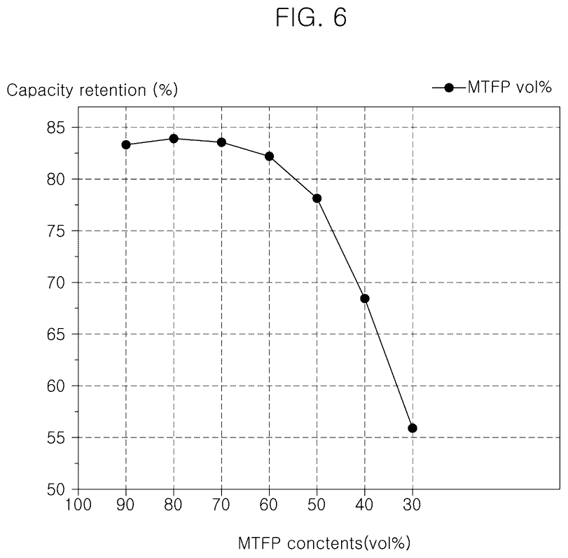

FIG. 6 shows a graph depicting high-temperature cycle-life characteristics (capacity retention ratio) depending on the volume (vol %) of methyl 3,3,3-trifluoropropionate (MTFP) relative to the electrolyte in Examples 1 to 3 and Comparative Examples 4 to 7.

In comparative Example 3 where the volume of MTFP relative to the electrolyte was 100 vol %, the complete dissolution of the lithium salt LiPF₆ was impossible. The lithium secondary batteries using electrolytes in which the MTFP:FEC volume ratio was 9:1 to 7:3, that is, the volume of MTFP relative to the electrolyte was 90 to 70 vol % showed excellent capacity retention ratios. The lithium secondary battery showed the highest capacity retention ratio when the MTFP:FEC volume ratio was 8:2, that is, the volume of MTFP relative to the electrolyte was 80 vol %.

These results verified that lithium secondary batteries further containing fluoroethylene carbonate (FEC) as an electrolyte solvent showed superior high-temperature cycle-life characteristics (capacity retention ratio) compared to lithium secondary batteries simply containing methyl 3,3,3-trifluoropropionate (MTFP) alone as an electrolyte solvent.

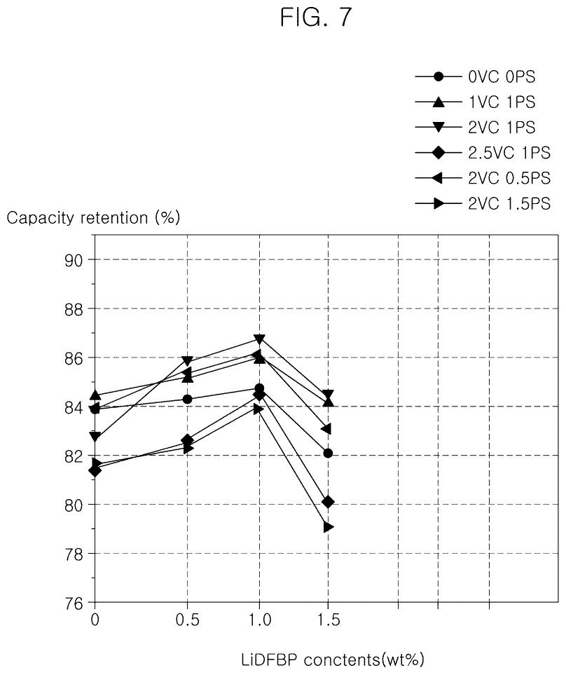

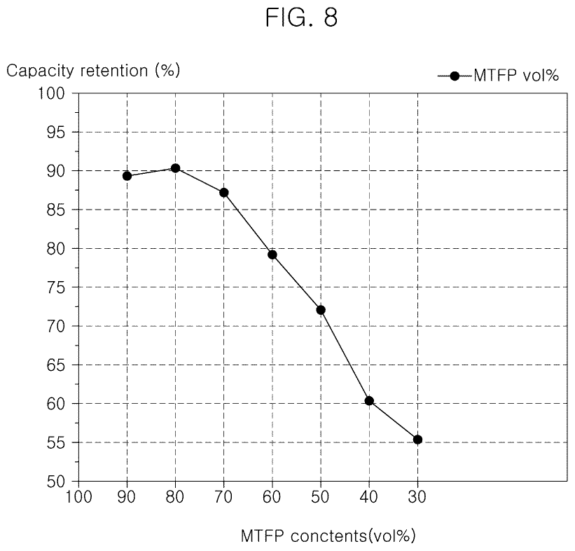

FIG. 7 shows a graph depicting high-temperature cycle-life characteristics (capacity retention ratio) depending on the content of lithium difluoro(bisoxalato) phosphate (LiDFBP) in Examples 2 and 4 to 8 and Comparative Examples 8 to 25.

The lithium secondary batteries of Examples 2 and 4 to 8 and Comparative Examples 8 to 25 were manufactured by adding three types of additives (vinylene carbonate (VC), 1,3-propane sultone (PS), and lithium difluoro(bisoxalato) phosphate (LiDFBP)) in different contents to an electrolyte in which the MTFP:FEC volume ratio was 8:2, that is, the volume of MTFP relative to the electrolyte was 80 vol %. The lithium secondary batteries were measured for high-temperature cycle-life characteristics (capacity retention ratio).

It was verified that the additive LiDFBP undergoes rapid decomposition in the early stage during charge to form a stable film and suppress the initial decomposition of the fluorinated solvent. This contributes to the cycle-life performance of the MTFP solvent composition.

It was also verified that the co-application of the additives VC and PS capable of forming an SEI layer at the cathode and anode exhibited an excellent capacity retention ratio compared to the application of the additive LiDFBP alone.

It was especially verified that a combination of 0.5 to 1.0 wt % of LiDFBP, 1.0 to 2.0 wt % of VC, and 0.5 to 1.0 wt % of PS showed excellent capacity retention.

### (2) Evaluation of Room-Temperature Output Performance

The batteries manufactured in Examples 1 to 7 and Comparative Examples 1 to 33 were compared with respect to the discharge capacities at low high rates.

Specifically, at 25° C., the batteries were charged at a rate of 0.5 C (low rate) and 4.0° C. (high rate) and discharged at 0.5 C, and their discharge capacities depending on the rate were measured and compared.

The output performance was obtained using Equation 2 below.

$$Output performance = ( Discharge capacity at a rate of 4 C / Discharge capacity at a rate of 0.5 C ) \qquad [ Equation 2 ]$$

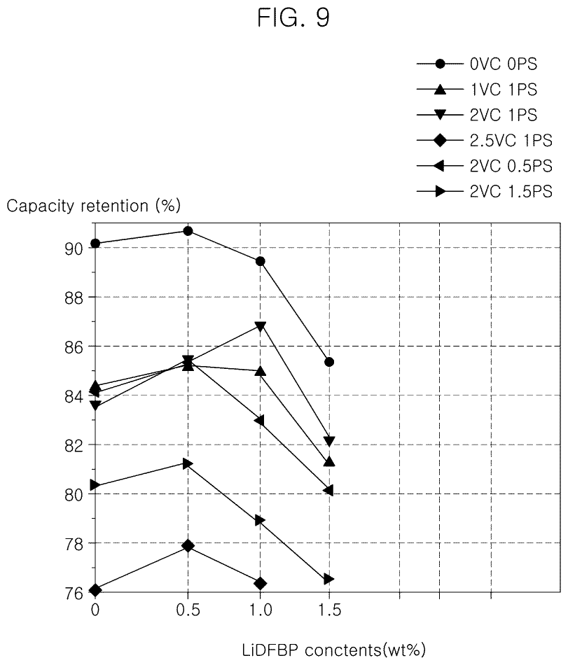

FIG. 8 shows a graph depicting room-temperature output performance depending on the volume (vol %) of methyl 3,3,3-trifluoropropionate (MTFP) in Examples 1 and 3 and Comparative Examples 4 to 7.

In Comparative Example 3 where the volume of MTFP relative to the electrolyte was 100 vol %, the complete dissolution of the lithium salt LiPF₆ was impossible. The lithium secondary batteries using an electrolyte in which the MTFP:FEC volume ratio was 9:1 to 7:3, equivalent to 90 to 70 vol % of MTFP relative to the electrolyte showed excellent capacity retention ratios.

In addition, the lithium secondary battery showed excellent room-temperature output characteristics when the volume of MTFP relative to the electrolyte was 70 to 90 vol %, and especially, exhibited the best room-temperature output characteristics when the volume of MTFP relative to the electrolyte was 80 vol %. Thereafter, it was verified that the room-temperature output performance was reduced as the volume of MTFP relative to the electrolyte decreased to 80 vol % or less.

FIG. 9 shows a graph depicting room-temperature output performance depending on the content (wt %) of lithium difluoro(bisoxalato) phosphate (LiDFBP) in Examples 2 and 4 to 8 and Comparative Examples 8 to 25.

The lithium secondary batteries were manufactured by adding three types of additives (vinylene carbonate (VC), 1,3-propane sultone (PS), and lithium difluoro(bisoxalato) phosphate (LiDFBP)) in different contents to an electrolyte in which the MTFP:FEC volume ratio was 8:2, that is, the volume of MTFP relative to the electrolyte was 80 vol %. The lithium secondary batteries were measured for room-temperature output performance.

The lithium secondary batteries showed excellent output performance compared to Comparative Example 2 when the VC content was in the range of 1.0 wt %≤VC≤2.0 wt %, like in the measurement of high-temperature cycle-life characteristics (capacity retention ratio).

The lithium secondary batteries showed excellent output performance compared to Comparative Example 2 when the PS content was in the range of 0.5 wt %≤PS≤1.0 wt %, as observed in the measurement of high-temperature cycle-life characteristics (capacity retention ratio).

The application of 0.5 wt % of LiDFBP resulted in the highest output performance, and even a content of 1.0 wt % for effectiveness of durability showed excellent output performance compared to Comparative Example 2. However, the application of LiDFBP in excess of 1.0 wt % or more increased the resistance layer due to continuous electrochemical decomposition.

Although the present disclosure has been described with reference to the accompanying drawings and the above exemplary embodiments thereof, the present disclosure is not limited thereto but defined by the appended claims. Therefore, those skilled in the art may make various modifications and changes to the present disclosure without departing from the technical idea of the present disclosure defined by the appended claims.

What is claimed is:

1. An electrolyte for a secondary battery, the electrolyte comprising:
solvent component comprising methyl 3,3,3-trifluoropropionate (MTFP);
a metal salt; and
an additive.

2. The electrolyte of claim 1, wherein the metal salt comprises a lithium salt.

3. The electrolyte of claim 1, wherein the solvent component further comprises fluoroethylene carbonate (FEC).

4. The electrolyte of claim 1, wherein the methyl 3,3,3-trifluoropropionate (MTFP) constitutes 70 to 90 vol % relative to a total volume of the electrolyte.

5. The electrolyte of claim 1, wherein the additive comprises lithium difluoro(bisoxalato) phosphate (LiDFBP).

6. The electrolyte of claim 5, wherein the lithium difluoro(bisoxalato) phosphate (LiDFBP) constitutes 0.5 to 1.0 wt % relative to a total weight of the electrolyte.

7. The electrolyte of claim 1, wherein the additive comprises vinyl carbonate (VC).

8. The electrolyte of claim 7, wherein the vinylene carbonate (VC) constitutes 1.0 to 2.0 wt % relative to a total weight of the electrolyte.

9. The electrolyte of claim 1, wherein the additive comprises 1,3-propane sultone (PS).

10. The electrolyte of claim 9, wherein the 1,3-propane sultone (PS) constitutes 0.5 to 1.0 wt % relative to a total weight of the electrolyte.

11. A method for preparing an electrolyte for a secondary battery, the method comprising:
adding a lithium salt and an additive to a solvent component, wherein the solvent component comprises methyl 3,3,3-trifluoropropionate (MTFP).

12. The method of claim 11, wherein the solvent component further comprises fluoroethylene carbonate (FEC).

13. The method of claim 11, wherein methyl 3,3,3-trifluoropropionate (MTFP) is prepared at a concentration of 70 to 90 vol % relative to a total volume of the electrolyte.

14. The method of claim 11, wherein the additive further comprises lithium difluoro(bisoxalato) phosphate (LiDFBP).

15. The method of claim 14, wherein lithium difluoro(bisoxalato) phosphate (LiDFBP) is added at a concentration of 0.5 to 1.0 wt % relative to a total weight of the electrolyte.

16. The method of claim 11, wherein the additive further comprises vinylene carbonate.

17. The method of claim 16, wherein vinylene carbonate is added in at a concentration of 1.0 to 2.0 wt % relative to a total weight of the electrolyte.

18. The method of claim 11, wherein the additive further comprises 1,3-propane sultone (PS).

19. A secondary battery comprising the electrolyte of claim 1.

20. A vehicle comprising a battery of claim 19.
